(19) United States
(12) Patent Application Publication
(10) Pub. No.: US 2014/0136228 A1
(43) Pub. Date: May 15, 2014

(54) SYSTEMS AND METHODS FOR COMPOSING PROFILES OF CLINICAL TRIAL CAPACITY FOR GEOGRAPHIC LOCATIONS

(71) Applicant: ViS Research Institute - Tecnologias e Serviços Para Pesquisa Clínica S/A, Sao Paulo (BR)

(72) Inventors: Fabio Albuquerque Thiers, New York, NY (US); Daniel B. Martines, Lexington, MA (US); Henrique M. Da Silva, Sao Paulo (BR); Guilherme B. Boettcher, Sao Paulo (BR); Marc Wilenzick, Briarcliff Manor, NY (US)

(73) Assignee: ViS Research Institute - Tecnologias e Serviços Para Pesquisa Clínica S/A, Sao Paulo (BR)

(21) Appl. No.: 14/157,740

(22) Filed: Jan. 17, 2014

Related U.S. Application Data
(63) Continuation-in-part of application No. 13/708,248, filed on Dec. 7, 2012.
(60) Provisional application No. 61/695,797, filed on Aug. 31, 2012.
(60) Provisional application No. 61/569,098, filed on Dec. 9, 2011.
(60) Provisional application No. 61/753,660, filed on Jan. 17, 2013.

(51) Int. Cl. G06F 19/00

(52) U.S. Cl. CPC G06F 19/363
USPC 705/2

(57) ABSTRACT

The invention generally relates to systems and methods for composing location profiles for use in planning clinical trials. Location profiles may depict the aggregate clinical research capacity of geographic locations based on research centers within those locations among other factors. In certain aspects, the invention provides systems and methods for providing disease-specific information about clinical trial capacity by location. The information can be aggregated from several sources. A user can change a geographical scope and the system can alter the display to include data specific to the changed geographical scope.

### CROSS-REFERENCE TO RELATED APPLICATIONS

This application is a continuation-in-part of U.S. patent application Ser. No. 13/708,248, filed Dec. 7, 2012, which application claims the benefit of, and priority to, U.S. Provisional Patent Applications 61/695,797, filed Aug. 31, 2012, and 61/569,098, filed Dec. 9, 2011, the contents of each of which are incorporated by reference.

This application claims the benefit of, and priority to, U.S. Provisional Patent Application 61/753,660, filed Jan. 17, 2013, the contents of which are incorporated by reference.

### FIELD OF THE INVENTION

The invention generally relates to systems and methods for composing location profiles for use in planning clinical trials.

### BACKGROUND

A person suffering from a disease can typically only take a life-saving drug once it has been approved by the government. Government approval requires a series of clinical trials on a large number of patients. Planning clinical trials is a complex process that takes time and money as a trial planner mails feasibility questionnaires to clinical research centers in hopes that enough centers will send back answers. If the planner identifies enough centers with adequate capacity and willingness to conduct a trial, the potentially life-saving drug can enter clinical trials.

Trial planners have particular difficulty planning multi-site trials. Even if each research center sends back a completed feasibility questionnaire, the trial planner must identify what combination of centers provides the desired capacity. Unfortunately, organizing the results with regards to one variable, such as available patient population, interferes with the optimization of other variables, such as regulatory environment. Planning a clinical trial is an expensive and ad hoc project in which a trial planner goes through survey results trying to put together a suitable group of research centers. Information about the centers, and factors such as available patient population and local regulatory rules, if available at all, is scattered across complex and incomplete papers or spreadsheets, the nature of which does little to aid decision-making.

### SUMMARY

The invention provides systems and methods for profiling the aggregate clinical research capacity of geographic locations based on research centers within those locations among other factors. The invention includes the insight that geographic location is a very valuable way to organize information about clinical research capacity. A trial planner seeking to optimize one or more criteria can find that a geographic location may be quickly identified as satisfying the one or more criteria. For example, a person planning a multi-site trial may want a regulatory fast track, a large number of patients that smoke, research centers with a certain quality of peer rating, or a combination thereof. By looking at a number of cities or nations, or toggling between a city-level view and a nation-level view, a planner may rapidly find a geographic location encompassing a plurality of research centers that, in the aggregate, provide good clinical trial capacity.

The inventors have discovered that location is one of the most important factors that applies to site allocation. The characteristics of a location can drive much (e.g., 50% or more) of the centers' productivity and attractiveness. For example, a site might have all the equipment and expertise, but the performance of that site will depend on the number of patients available in that location and the timelines that would be in effect. Performance can also be affected by local availability of research personnel and even the local competition for patients (i.e., local research activity). A large number of suitable centers in a location can also affect performance, quality, or both from a practical perspective as it can lead to easier and more efficient site monitoring. Additionally, cost, regulatory and local customization requirements (e.g., time zone, translations, etc.) may be driven primarily by the center's location. These may all be major factors in the attractiveness of a center to a trial planner.

It follows that knowing about the location can be critical to site selection. For many trial planners, site selection starts with country selection and then moves down. Systems and methods of the invention provide location profiles to empower location selection, leading to better site selection. Aggregating available information and synthesizing new information into location profiles puts all of this detailed information at the fingertips of trial planners for the first time, in an easy to use interface.

Thus, a method and system for providing location profiles relating to research capacity solves the need for a way to synthesize useful trial-planning information from the disaggregated data bits that are found among feasibility questionnaire results, government regulations, maps, or other sources. A location profile gives a planner valuable trial planning information, allowing a clinical trial to be started quickly. As a result, life-saving drugs become available more quickly than otherwise. Additionally, a location profile serves as both as dashboard and also as the host for links to other analytics (e.g., visualizations and center profiles).

Systems and methods of the invention further provide, as discussed in greater detail herein, features such as: links or third-party data coming though APIs or references about the location of interest; ability for crowd-sourced input from trial planner users about the locations; presentation of main research entities and professionals operating in a given location; presentation of benchmarks (scores) that compare locations of a similar level (city-city or state-state) across the globe, within a country or region or across pre-selected locations; and global scores based on weighted average inputs, wherein the weights may be user-specified.

In certain aspects, the invention provides a system for providing information about clinical trial capacity by location. The system includes a server computer operable to provide a display comprising disease-specific information about clinical trial capacity associated with a location. The system can receive user input indicating a change in geographical scope. The system can alter the display to include data specific to the changed geographical scope. The disease-specific information may be a mashup of data from a plurality of sources. The disease-specific information may include data from an external data service. The disease-specific information could include internal data integrated with the data from the external data service.

In some embodiments, the server computer is operable to provide the display at a country level and transition, based on the user input, the display to a city level.

In related aspects, the invention provides a method of providing information about clinical trial capacity by location by using a server computer to provide a display comprising disease-specific information about clinical trial capacity associated with a location. The server can receive user input indicating a change in geographical scope and alter the display to include data specific to the changed geographical scope. The method may include any of: obtaining raw data from a plurality of sources and composing the display to include the raw data from the plurality of sources; receiving a user query and providing the display to include a result that satisfies the user query; interrogating an outside data source based on the user query and obtaining the result from the outside data source; providing a disease-specific location profile for each of a plurality of nations and for at least one city within each of the plurality of nations; or a combination thereof.

Aspects of the invention provide a system for benchmarking clinical trial capacity of a geographical location. The system includes a server computer operable to receive information about an aggregate capacity to conduct a disease-specific clinical trial available at each of a plurality of geographic locations and to calculate a benchmark indicating the aggregate capacity for one of the geographic locations relative to the aggregate capacity of all of the plurality of geographic locations. The server can then provide the benchmark to a trial planner.

In some embodiments, the benchmark is provided as a percentile display. Preferably, the plurality of geographical locations includes cities and countries. Some of the plurality of geographical locations may each be contained within another of the plurality of geographic locations. The server can provide benchmarks for a plurality of aspects of clinical trial capacity.

Related aspects of the invention provide methods of benchmarking clinical trial capacity of a geographical location by using a server computer to receive information about an aggregate capacity to conduct a disease-specific clinical trial available at each of a plurality of geographic locations and calculate a benchmark indicating the aggregate capacity for one of the geographic locations relative to the aggregate capacity of all of the plurality of geographic locations. By these means, a benchmark can be provided to a trial planner.

In some embodiments, each geographic location has a plurality of clinical research centers sited therein. The information about the aggregate capacity may include data retrieved from a public data source and input from a user. The aggregate capacity may include identities of clinical research centers in the geographic location and the benchmark comprises a combination of weighted scores associated with the clinical research centers. The method may involve receiving survey results from a plurality of user's interactions with the server and aggregating the results to create the aggregate capacity.

In some aspects, the invention provides a system for collecting information about clinical trial capacity of a geographical location. The system includes a server computer operable to provide a display comprising an identification of a geographical location; receive, from a first user, input comprising information about clinical trial capacity of a geographical location; receive, from a second user, additional input; assign different weights to the input and the additional input; calculate a capacity value based on the weighted inputs; and store the calculated value for subsequent access by a clinical trial planner. The clinical trial capacity of a geographical location may include an average amount of time to obtain regulatory approval in that location. The clinical trial capacity of a geographical location may include information about an available patient population.

In any system or method described herein, a server may comprise a processor operably coupled to a tangible, non-transitory memory. In any system or method described herein, a server may receive a user input via a user's interaction with a computer device comprising a memory coupled to a processor, the computer device communicatively coupled to the server by a network. In any system or method described herein, a server may provide a display using markup language that is rendered on a user's computer device as a web page.

### BRIEF DESCRIPTION OF THE DRAWINGS

FIG. 1 shows a system for location profiling.

FIG. 2 depicts a screen for finding location profiles.

FIG. 3 is a screen displaying a geo-referenced location icon.

FIG. 4 shows an link for accessing a location profile.

FIG. 5 gives an example location profile for France.

FIG. 6 represents a screen for collecting input from center representatives.

FIG. 7 depicts a screen for collecting center information.

FIG. 8 is a location profile for Germany.

FIG. 9 shows use of a screen for specifying a disease and finding locations.

FIG. 10 gives a nation-level location profile for the United States.

FIG. 11 illustrates a city-level profile.

FIG. 12 presents a screen providing location benchmarks.

FIG. 13 diagrams a system according to certain embodiments.

FIG. 14 depicts a system according to some embodiments.

### DETAILED DESCRIPTION

The invention provides systems and methods for composing, displaying, and using location profiles. A location profile can include a display that provides information about a geographic location. Systems and methods of the invention provide location profiles that give information about clinical trial capacity associated with a location. In preferred embodiments, the location profiles can be disease-specific, and thus can show a capacity of a geographic location for performing a clinical trial specific to a certain disease. Some prior art directories addressed in-progress clinical trials at specific contract research organizations (CROs). Such directories tend to confound, not help, the problem, due to the fact that an in-progress clinical trial actually deducts from the present capacity of a geographical location to support a clinical trial (i.e., whatever number of patients are presently enrolled in a clinical trial are typically not then part of the clinical trial capacity associated with that location). Systems and methods of the invention recognize that a geographic location may be of primary interest to a planner (e.g., New England, the south of France, Latin America, São Paulo, Guangzhou, the greater Guangzhou metropolitan area, Canada, central Oregon, zip code 28804, the Willamette Valley, or an arbitrary area of the surface of Earth). In fact, once insight of the invention is that two geographical locations that are very different in scale may be of important similarity in terms of capacity for clinical trials. For example, a map view of the United States in a web browser that is “zoomed in” so that downtown Boston, Mass., fills most of the viewing area (such that everything visible in the map view is a geographical location) may have similar capacity for a clinical trial related to influenza as Slovakia—despite the significant difference in square mileage of those two locations.

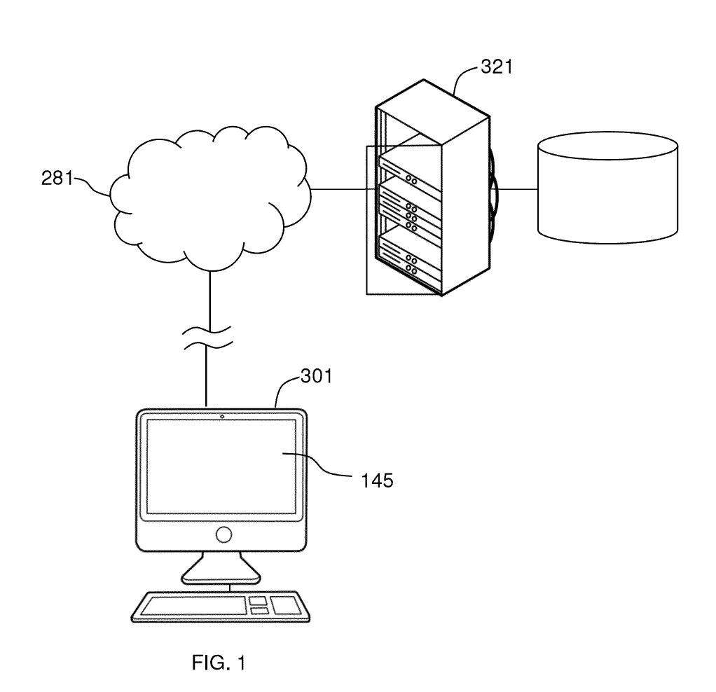

FIG. 1 shows a system for location profiling. A trial planner can use computer 301 to access profiles composed and provided by server 321 via network 281. Computer 301 can provide display 145 to give the trial planner a home screen, or dashboard, for finding and using location profiles.

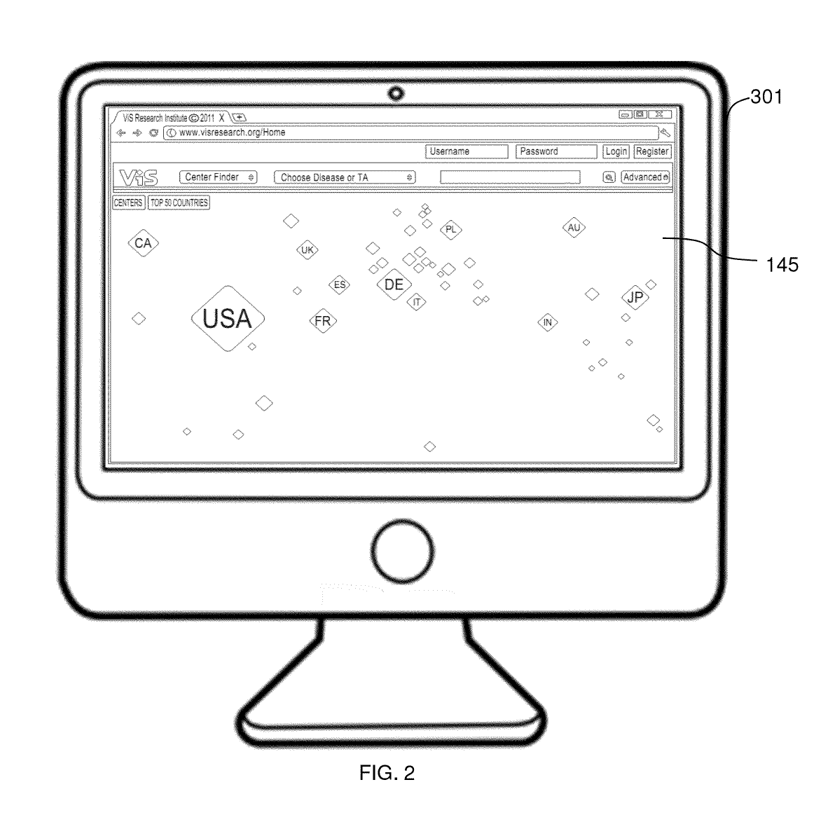

FIG. 2 depicts an exemplary display 145 for finding location profiles. From display 145, a trial planner can select a disease and can view indicators of geographic locations that have research capacity pertinent to the disease. As shown in FIG. 2, the indicators may be diamond-shaped elements corresponding to different geographic locations. Each element can operate like an icon or link to give the planner more information about the location. When the planner clicks one of the elements, the display can zoom in to reveal more detail.

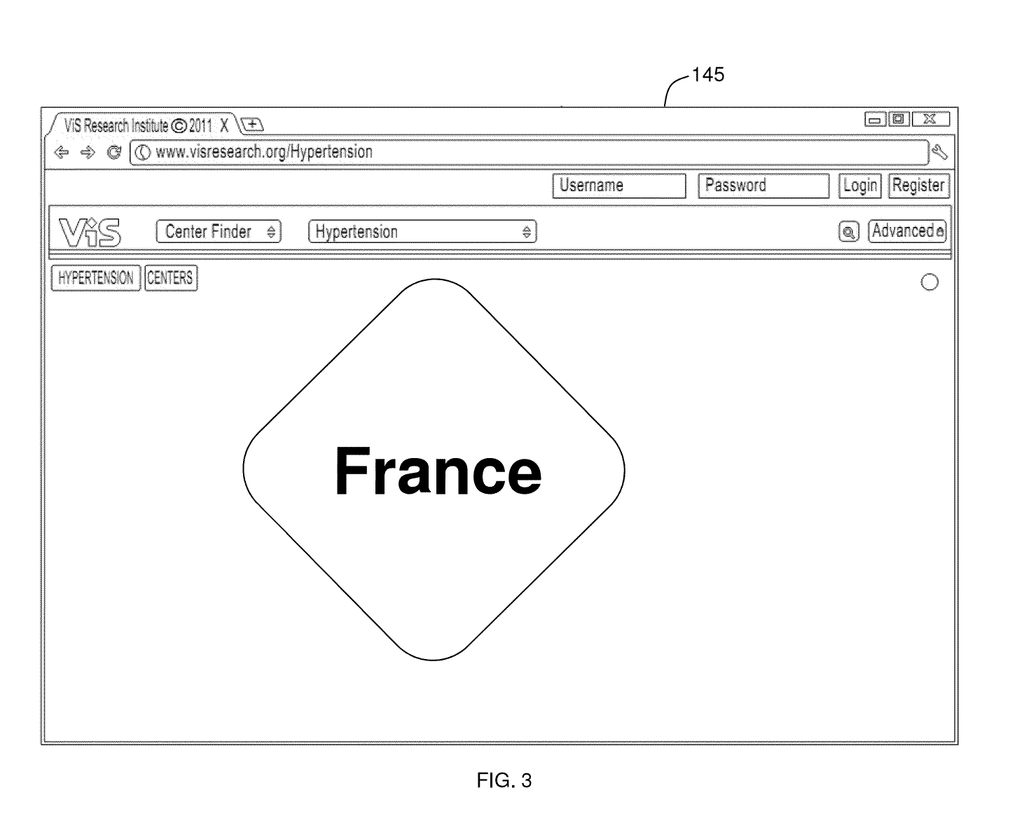

FIG. 3 is a screen displaying a geo-referenced location icon. Here, a planner has input hypertension as the study disease and has zoomed in on France as the location of interest. While discussed herein in terms of certain computer-based interactions and graphical user interface (GUI) elements, methods and systems of the invention can operate by a variety of controls. For example, zooming in can be accomplished by choosing an element (e.g., single click, single touch on touch screen, typing first few letters, etc.), by scrolling a mouse wheel, by pinching on a touch screen, or any other input. For the sake of clarity, certain actions are described in familiar terms (right click on), but one of skill in the art will recognize that those actions can be accomplished by other, similar actions (ALT-Windows key; CTRL-click; double tap, etc.).

The element shown in FIG. 3 representing France allows a planner to access more information. For example, right clicking on the element can make a menu appear.

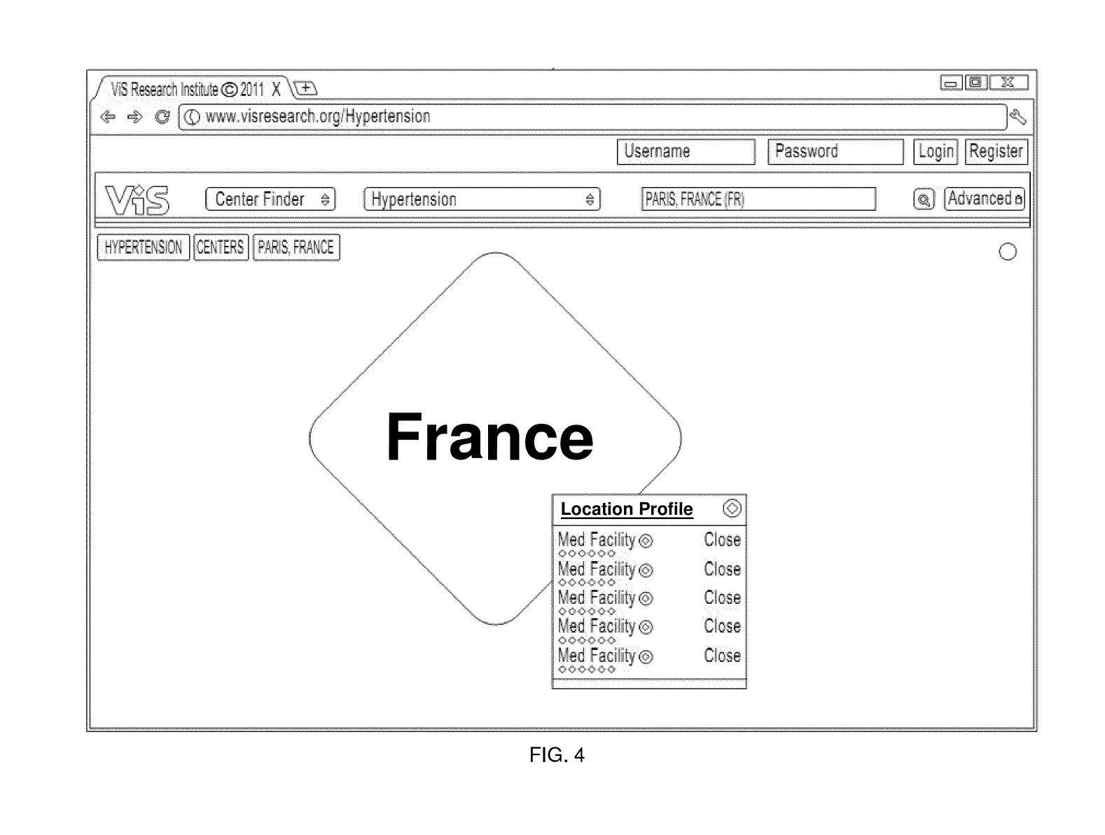

FIG. 4 shows a pop-up menu for retrieving information. At the top of the menu appears a link for accessing a location profile. The “Location Profile” link can appear for many scales of the display. For example, a user could zoom into a city or zoom out to a continent, and the link will be operable to obtain a location profile of the commensurate geographic scope. A location profile can be an interactive disease-specific dashboard useful to a trial planner to identify research capacity in a location.

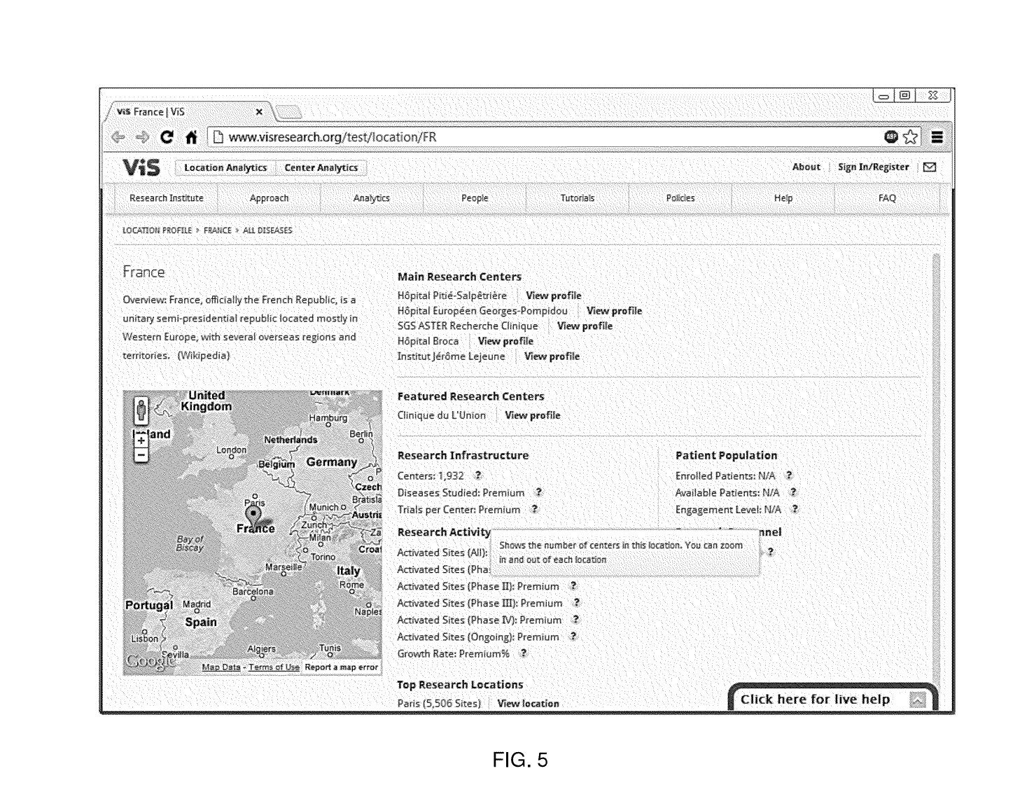

FIG. 5 gives an example location profile for France. The system composes information from a plurality of sources. For example, the profile may include a map, a text summary of the profiled geographic location, a list of main research centers, information about research infrastructure, information about patient population, information about research activity, other information, or a combination thereof. The information may come from public sources or an internal database. For example, a text summary may be pulled from Wikipedia or a similar site.

In certain embodiments, a location profile provides information about active clinical trials or sites that are active in clinical trials. For example, under “Research Activity”, a list of activated sites by phase of clinical trial can be given, with a number of sites that is active in each phase. Remembering that all information can be organized in a disease-specific fashion, this information provides a snapshot of the amount of, and progress of, clinical research in a geographical area pertaining to a particular disease.

A location profile may include links or third-party data coming though APIs or references about the location of interest. For example, a location profile may link to an independent database of national regulatory schemas. Thus a trial planner may see, on a location profile, summary information of applicable regulations in the geographical location that is being profiled. If, for example, a particular geographical location spans a border between two countries, that profile can display the average time to approval for each of those two countries. As another example, third-party data such as market information may be included in a location profile. A market research firm may have independently studied and determined a growth rate of a particular sector of a pharmaceutical market, and that third-party information may be channeled through to appear on the location profile.

In some embodiments, a trial planner may, from a location profile, view a presentation of main research entities and professionals operating in a given location. For example, U.S. Pub. 2013/0151276 (incorporated by reference) describes providing a profile of a research center. Such a center-specific profile (or similarly, an investigator-specific profile) may be linked to from within a location profile. An insight of the invention is that a profile of clinical trial capacity in a geographical location and a profile of a CRO are distinct things, serving separate purposes, and that the availability of the latter did not satisfy the demand for the former. (By analogy, knowing that some certain business in Roanoke has a printing press does not reveal whether one would be able to get 100,000 books printed in central Virginia within the next five days.) Thus, a location profile as provided by the invention, depicts clinical trial capacity for a geographical location and may optionally also include information about specific research entities or personnel in that area (e.g., in the form of summary information or links to profiles specific to those entities or personnel). As discussed further herein, information may be provided in levels, wherein any public user can browse to and view certain qualities of information, but more detailed or specific information may be restricted to registered users or paid subscribers, for example.

As shown in FIG. 5, the numbers of active sites are not shown, and the word “premium” is displayed instead. In some embodiments, this is a feature of a commercial clinical trial planner service, in which a summary profile is available without charge, but detailed information is provided for a fee.

Key features of in the invention thus include providing a valuable commercial service that can be driven from a basic location profile page; providing disease-specific location profiles; providing location profiles that are composed for every scale (e.g., single block, city, county, state, nation, continent); summarizing all of the information on a single page; integrating information from numerous sources including, for example, an online mapping service, an online encyclopedia, a government registry of clinical trials, a national library of medicine publication database, or others; showing the integrated information as a mashup in a single attractive page; providing relevant regulatory guidance or benchmarking documents; providing contacts for relevant regulatory bodies or other service providers (such as couriers or translators) who may assist in set up a trial in the area; and using a location profile to show a regional capacity to conduct clinical trials on a drug that is proposed to treat a specific disease.

Additionally, a location profile may be organized around any suitable parameter. While discussed above generally in terms of countries or cities as well as counties, states, and other levels, any level is possible including, for example: regions (e.g., “the south” in the United States or the Pacific Northwest); continents or subcontinents; geographically-identified regions (e.g., sub-Saharan Africa, the Loire valley in France, Latin America); zip code or postal code; named neighborhood (e.g., “The Castro”); economically or developmentally defined categories (e.g., emerging markets, BRIC countries (where BRIC is a grouping that refers to Brazil, Russia, India, and China); treaty signatories; the presence of historical co-collaborators; etc.). The geographical levels may be flexible. In some embodiments, a geographical level is defined by user input. For example, a user views a map in a web browser and uses a mouse, touchscreen, or other device to zoom in to a particular level. The resulting map that is visible on screen defines the level of geographical location for a location profile, scorecard, or both.

In certain embodiments, the invention provides systems and methods for collecting information about clinical trial capacity of a geographical location. Models of information-collecting put forth by the invention could be described as wiki-data or crowdsourcing. Some data may be obtained from online sources (e.g., an online mapping service such as Google Maps, an online encyclopedia, a government registry of clinical trials such as clinicaltrials.gov, a national library of medicine publication database such as PubMed, or others) while some data may be provided by users such as representatives of clinical research centers.

In certain embodiments, the invention provides the ability for crowd-sourced input from trial planner users about the locations. That is, a trial planner may use a system of the invention to collect or view information about patient availability for a study relating to a specific disease in certain geographic locations, and then the trial planner may also provide information to the system from their own knowledge. An individual user may input their own qualitative knowledge of a geographical area or a specific center, researcher, etc., or may translate their qualitative knowledge into quantitative knowledge (e.g., by a multi-starred review system or a scoring system). Thus where a geographical location appears through the system to have a very high patient availability for a certain condition (e.g., a high population affected with malaria), but one or a number of different trial planner experience that recruiting patients in that area is unduly challenging (perhaps for some unseen structural reason), those planners can input their evaluations, which the system can then fold into the data, so that future searchers see the input from the previous trial planners. In some embodiments, the system will override “hard data” obtained from an extrinsic source on the strength of crowd-sourced input. For example, if local directories indicate that two CROs are located within some certain national province, but numerous planner report that one has closed down, the system can respond by de-listing the reportedly closed CRO. As just discussed, crowd-sourcing may include receiving data from trial planners. Additionally or alternatively, information is received from professionals such as representatives of the research centers.

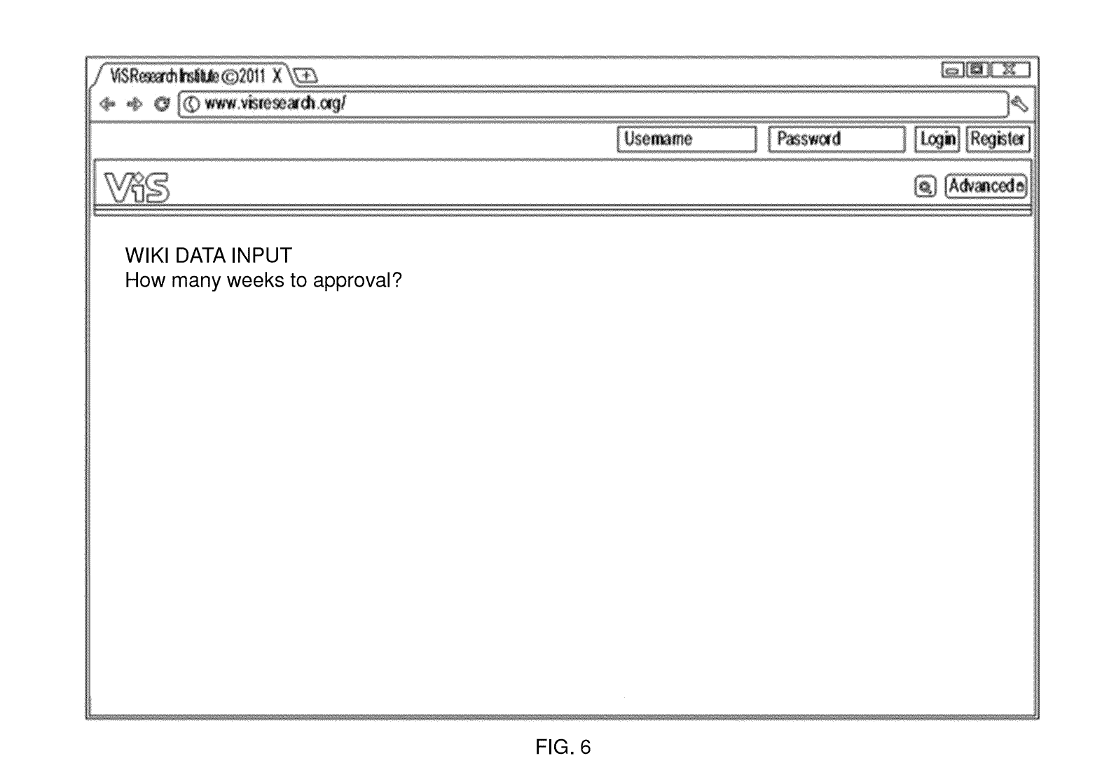

FIG. 6 represents a screen for collecting input from center representatives. Systems and methods of the invention can be used to present data collection prompts, such as surveys or questions. One of skill in the art will recognize categories of information that may be pertinent to disease-specific clinical trials and questions may be presented to solicit that information. Information that may be solicited is disclosed in U.S. Pub. 2013/0151280; U.S. Pub. 2013/0151279; U.S. Pub. 2013/0151278; U.S. Pub. 2013/0151277; U.S. Pub. 2013/0151276; and U.S. Pub. 2013/0151275, the contents of each of which is incorporated by reference in their entirety. In certain embodiments, information is gathered from center representatives by having those representatives fill out center profiles or other forms displayable on a computer screen.

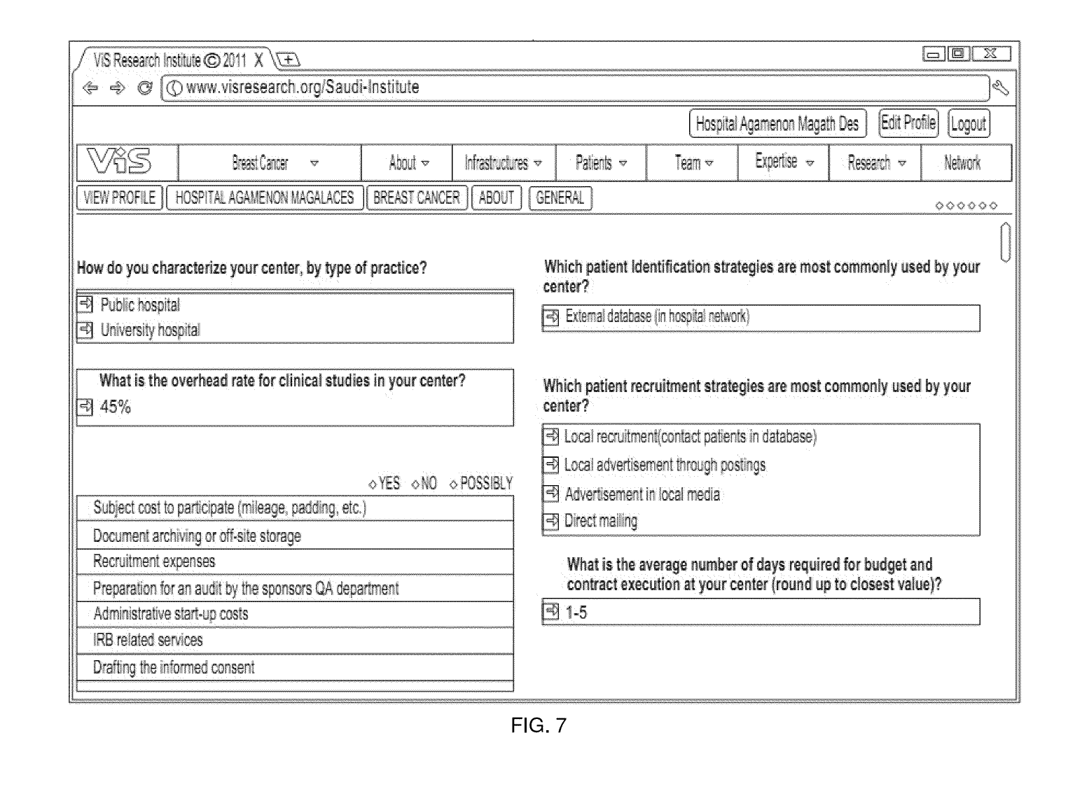

FIG. 7 depicts a screen for collecting center information. Examples of information that can be solicited include, for example, a number of months required to obtain a permit. In this example, a powerful aspect of the invention is illustrated. A center representative is asked information that will have a strong influence on a trial planner's likelihood of selecting the center. That information also applies more generally to the geographic location (e.g., the nation). The system can provide that information as part of a location profile once one person has provided it. However, when multiple different center representatives answer that question, the system can amalgamate the information to provide a more realistic value with a built-in confidence check. In certain embodiments, such a result is provided as an average of all of the inputs. In some embodiments, each value contributing the average is weighted according to the source of the information. For example, a representative of a center that has created a more complete profile may be given greater weight than a representative of a center that has a profile with but scant information. This gives a built-in confidence check on the wikidata method. Since research centers derive a commercial benefit from making their capacity known, individual centers from around the globe may give information. With that information, location profiles for many different cities and countries can be composed.

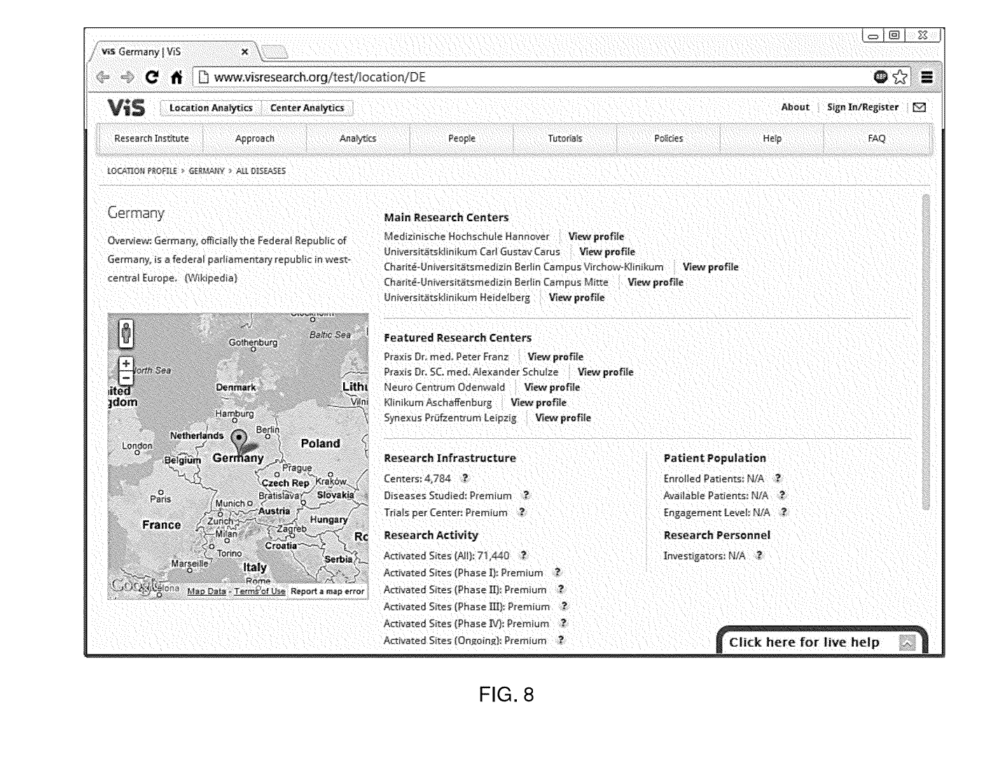

FIG. 8 illustrates a location profile for Germany. It should be noted that a location profile need not be disease-specific. For example, a trial planner may want to (based on personal preference) first browse for clinical trial capacity without specifying a disease and then, once looking at a location profile, select a disease and see how the profile changes. For example, where a trial planner has a full case load and is representing researchers working a number of different fields, the trial planner may be trying to do double duty, and look for good locations for several unrelated trials in a single browsing session.

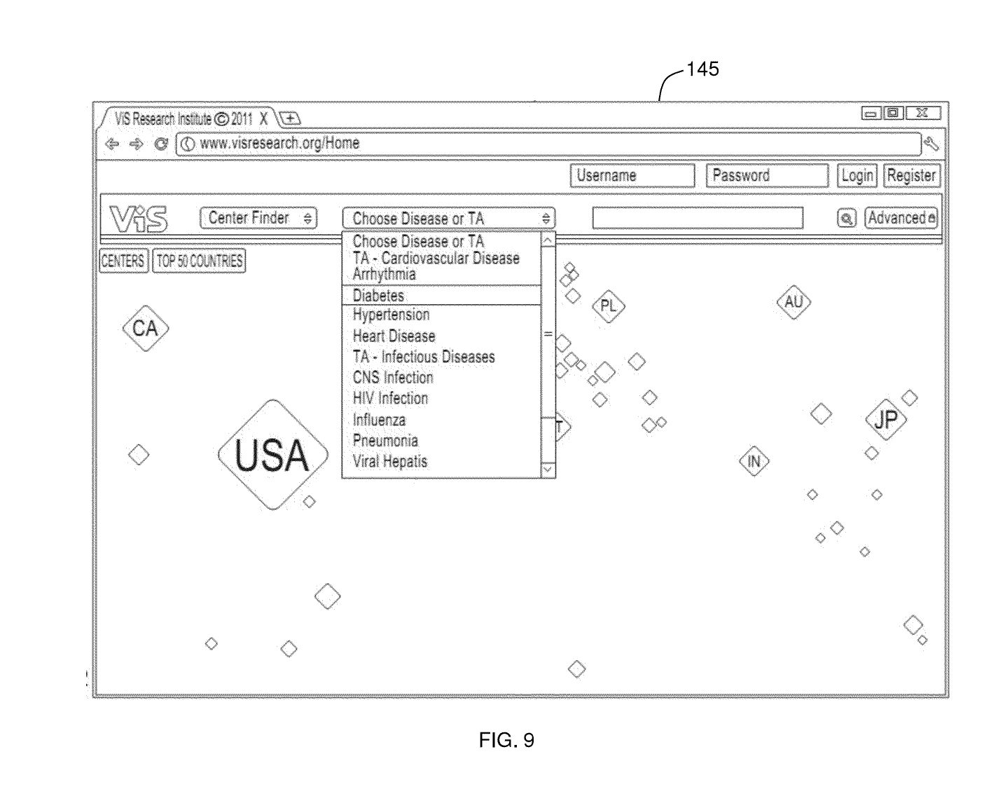

FIG. 9 shows use of a screen for specifying a disease and finding locations. The disease-selection menu depicted in FIG. 9 could be operable from any screen including, for example, from within a location profile.

FIG. 9 shows a high-level view of geography where many nations from around the globe are represented as diamond-shaped elements. A trial planner may choose one of the elements to “zoom in” on the location. For example, a user may click on the USA diamond to see a nation-level location profile for the United States.

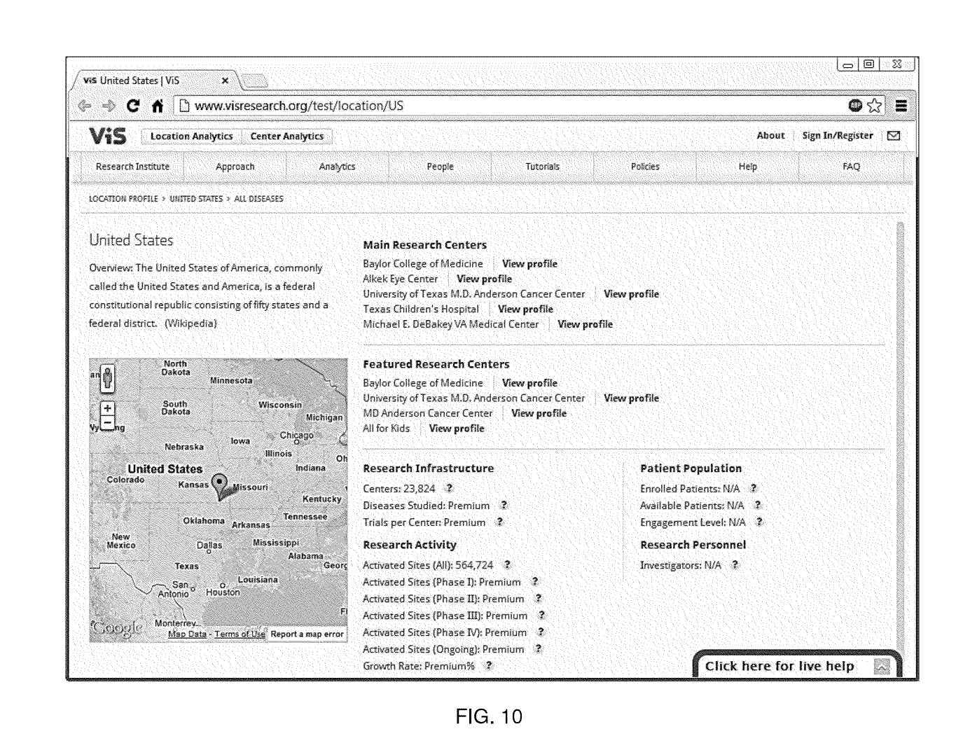

FIG. 10 gives a nation-level location profile for the United States. A location profile can progress from one geographic scale, or level, to another. For example, a user can browse from country-level profiles to city-level profiles or back. For example, a user could click on a specific city within the map shown in the profile in FIG. 10 to be taken to a city-level location profile.

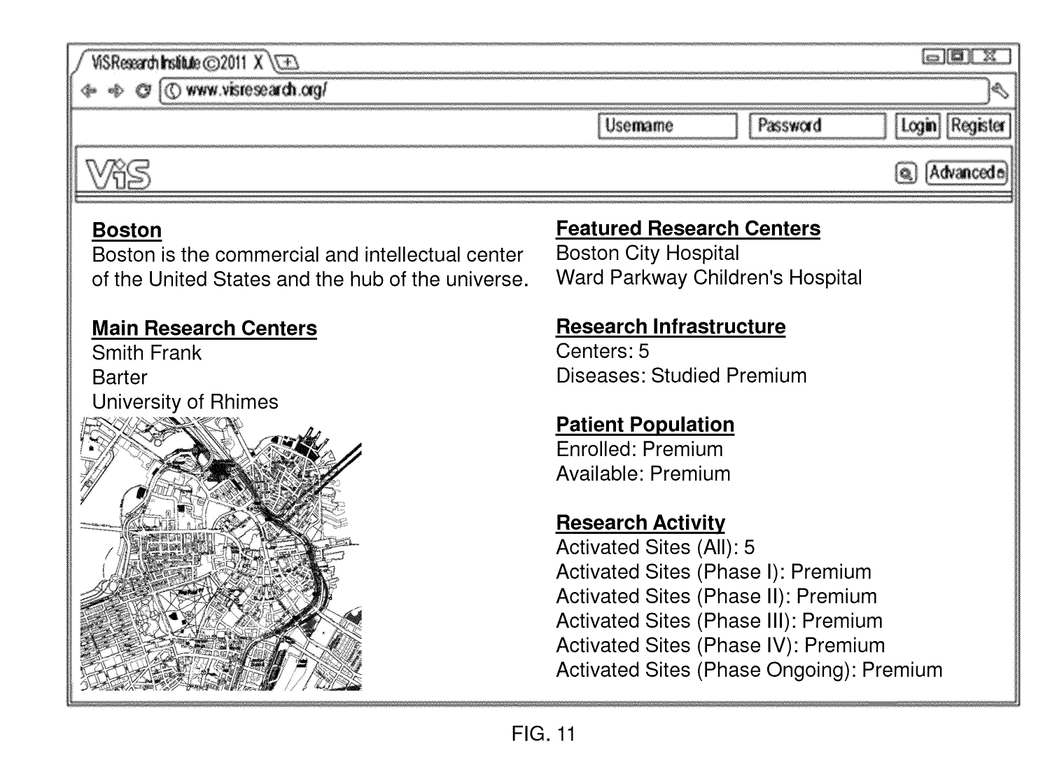

FIG. 11 illustrates a city-level profile. One insight of the invention is that changing profile levels could disrupt the information context within which a trial planner understands a location. The associated insight of the invention is that a trial planner derives value from information in the context of certain other information. Insights of the invention put to useful purpose by providing a benchmarking functionality that allows a trial planner to evaluate a center or a location based on variables that are benchmarked against information about other centers or locations available to the system.

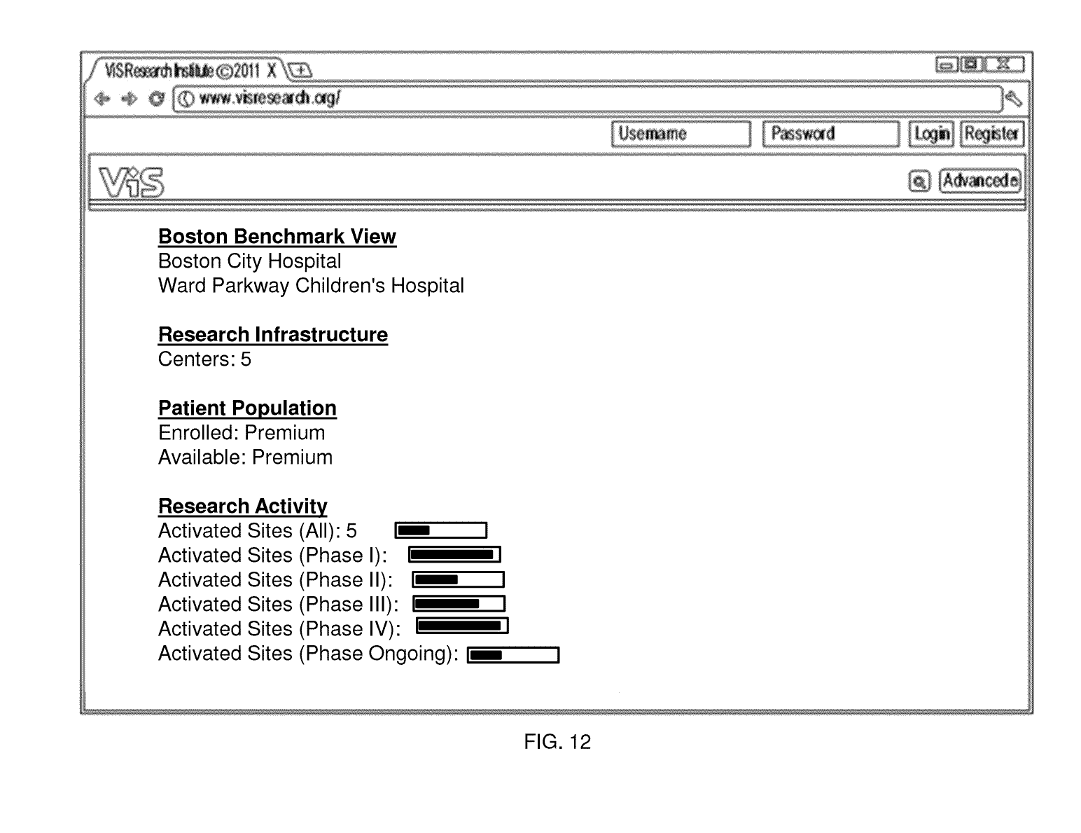

FIG. 12 presents a screen providing location benchmarks. FIG. 12 gives a few example variables. One of skill in the art will recognize a variety of variables that can be benchmarked, including any information discussed in those co-owned U.S. patent applications listed above.

The benchmarked variable can be displayed graphically. For example, a bar can be shown that gives a percentile value for a variable. Use of a percentile gives a comparison of a location to all of the locations in the system. A planner can change disease and can change profile level (e.g., country to city) on the fly, and the system can update the benchmarks.

Use of benchmarks against other locations (e.g., percentiles) gives important context to the information. For example, if a planner starts looking at Brazil and then dials down into Sao Paulo, the clinical trial capacity may appear large, but the planner may not have the immediate context for comparing that city to other cities in the globe. For example, if the planner sees that a city has 1,000 active Phase I clinical trials, but that the city is benchmarked at the 15th percentile, the planner then knows that there are other cities with many more Phase I clinical trials. Thus it is an insight of the invention that a percentile or a similar system for showing a rank of a location as compared to other locations or as compared to all of the locations is a functionality that well complements the ability to change between different scales of location profile. As a planner goes from country-level to city-level, it provides the important context to show how capacity in that city compares to capacities in all of the cities.

Related to benchmarks is the concept of scorecards. In certain embodiments, the invention provides systems and methods for generating scorecards for geographic locations. A scorecard can be a display or report that gives values for various variables, shows ranks on various axes, or represents qualities or capacities for a geographic location. In some embodiments, scorecards give global scores based on weighted average inputs, wherein the weights may be user-specified.

A scorecard gives a trial planner the ability to adjust relative weights that go into the creation of the scorecard in an interactive manner. For example, a scorecard can be obtained for one or more different geographic locations under consideration. In a preferred embodiment, a planner can assign or increase the strength of a consideration. The planner may, to illustrate, down-weight time for regulatory approval so that is only factors into about 5% of a location's score and up-weight patient population so that presently available patients factor into about 85% of the location's score. In some embodiments, the system provides scorecards that are composed and formatted for printing or inclusion in reports.

Those of skill in the art will recognize that systems and methods of the invention can be implemented through the use of computer devices, communication networks, and combinations thereof.

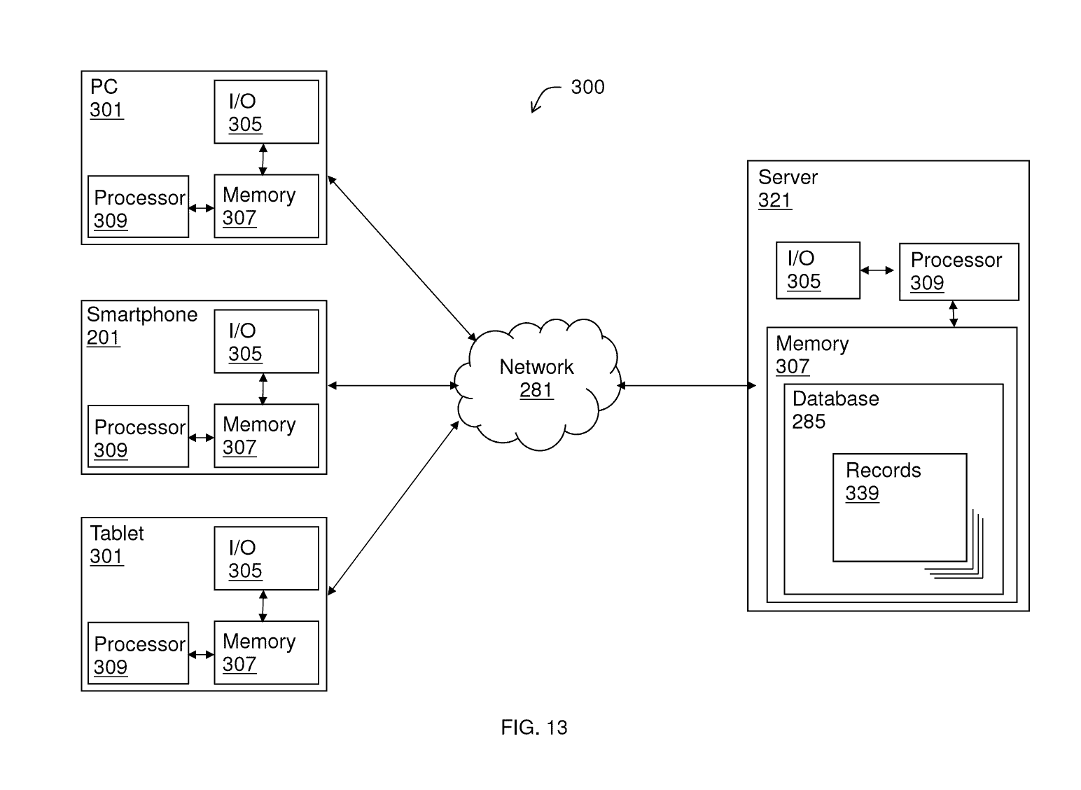

FIG. 13 diagrams a system 300 according to certain embodiments. System 300 preferably includes a server 321 in which a database 385 contains records 339 containing data about clinical trial capacity. A person can access profiles provided by the system through the use of a PC 301, a smartphone 201, a tablet 302, or other such devices. Each computer device preferably includes a memory 307 coupled to a processor 309 and one or more input/output mechanism 305.

Server 321 could include a rack-mounted computing device such as the server sold under the trademark BLADE by Hitachi (Santa Clara, Calif.). A PC 301 could be a computer device such as the PC sold under the trademark SERIES 9 by Samsung (Seoul, South Korea), a notebook or desktop computer sold by Apple (Cupertino, Calif.) or a desktop, laptop, or similar PC-compatible computer such as a Dell Latitude E6520 PC laptop available from Dell Inc. (Round Rock, Tex.). Such a computer will typically include a suitable operating system such as, for example, Windows 7, Windows 8, Windows XP, all from Microsoft (Redmond, Wash.), OS X from Apple (Cupertino, Calif.), or Ubuntu Linux from Canonical Group Limited (London, UK).

Memory 307 may be, for example, one or more of a hard disk drive, solid state drive (SSD), an optical disc, flash memory, zip disk, tape drive, “cloud” storage location, or a combination thereof. In certain embodiments, a device of the invention includes a tangible, non-transitory computer readable medium for memory. Exemplary devices for use as memory include semiconductor memory devices, (e.g., EPROM, EEPROM, solid state drive (SSD), and flash memory devices e.g., SD, micro SD, SDXC, SDIO, SDHC cards); magnetic disks, (e.g., internal hard disks or removable disks); magneto-optical disks; and optical disks (e.g., CD and DVD disks).

Processor 309 may be provided by one or more processors including, for example, one or more of a single core or multi-core processor (e.g., AMD Phenom II X2, Intel Core Duo, AMD Phenom II X4, Intel Core i5, Intel Core i& Extreme Edition 980X, or Intel Xeon E7-2820).

Input/output mechanism 305 may include a video display unit (e.g., a liquid crystal display (LCD) or a cathode ray tube (CRT)), an alphanumeric input device (e.g., a keyboard), a cursor control device (e.g., a mouse), a disk drive unit, a signal generation device (e.g., a speaker), a touchscreen, an accelerometer, a microphone, a cellular radio frequency antenna, and a network interface device, which can be, for example, a network interface card (NIC), Wi-Fi card, cellular modem, monitor, keyboard, mouse, data jack (e.g., Ethernet port, modem jack, HDMI port, mini-HDMI port, USB port), Wi-Fi card, touchscreen (e.g., CRT, LCD, LED, AMOLED, Super AMOLED), pointing device, trackpad, microphone, speaker, light (e.g., LED), light/image projection device, or a combination thereof.

In some embodiments, either of consumer computer 301 or server 321 may be a tablet or smart-phone form factor device and processor 281 can be provided by, for example, an ARM-based system-on-a-chip (SoC) processor such as the 1.2 GHz dual-core Exynos SoC processor from Samsung Electronics, (Samsung Town, Seoul, South Korea).

The subject matter described herein can be implemented as one or more computer program products, such as one or more computer programs tangibly embodied in an information carrier (e.g., in a non-transitory computer-readable medium) for execution by, or to control the operation of, data processing apparatus (e.g., a programmable processor, a computer, or multiple computers). A computer program may be deployed in any form, including as a stand-alone program or as a module, component, subroutine, or other unit suitable for use in a computing environment. A computer program (also known as a program, software, software application, app, macro, or code) can be written in any form of programming language, including compiled or interpreted languages (e.g., C, C++, Perl). Systems and methods of the invention can include instructions written in any suitable programming language known in the art, including, without limitation, C, C++, Perl, Java, ActiveX, HTML5, Python, Ruby on Rails, Visual Basic, or JavaScript. Programming in Java is discussed in Liang, Introduction to Java Programming, Comprehensive (8th Edition), Prentice Hall, Upper Saddle River, N.J. (2011) and in Poo, et al., Object-Oriented Programming and Java, Springer Singapore, Singapore, 322 p. (2008). A computer program may be developed in a development environment such as Ruby on Rails or Groovy and Grails. See, e.g., Metz, Practical Object-Oriented Design in Ruby: An Agile Primer, Addison-Wesley (2012).

In some embodiments, systems of the invention include data regarding clinical research centers stored in database 2013, e.g., within server 2005. A database application can be developed for use within server 2005. Any development environment, database, or language known in the art may be used to implement embodiments of the invention. In some embodiments, an object-oriented development language, database structure, or development environment is used. Exemplary languages, systems, and development environments for development and operation of database 2013 include Perl, C++, Python, Ruby on Rails, JAVA, Groovy and Grails, Visual Basic .NET, Smalltalk, Objective C, and SQL (e.g., in the context of a Relational Database Management System such as MySQL, Oracle, Informix, or Postgres). In some embodiments, implementations of the invention provide one or more object-oriented application and underlying databases for use with the applications. Databases are discussed in Date, C. J., Database design and relational theory, 2012, O'Reilly Media, Inc., Sebastopol, Calif., 260 pages, and Teorey, et al., Database Modeling and Design, 2011, Elsevier, Burlington, Mass., 304 pages.

In some embodiments, systems and methods of the invention can be developed using the Groovy programming language and the web development framework Grails or a similar product. Grails is an open source model-view-controller (MVC) web framework and development platform that provides domain classes that carry application data for display by the view. Grails domain classes can generate the underlying database schema. Grails provides a development platform for applications including web applications, as well as a database and an object relational mapping framework called Grails Object Relational Mapping (GORM). The GORM can map objects to relational databases and represent relationships between those objects. GORM relies on the Hibernate object-relational persistence framework to map complex domain classes to relational database tables. Grails further includes the Jetty web container and server and a web page layout framework (SiteMesh) to create web components. Groovy and Grails are discussed in Judd, et al., Beginning Groovy and Grails, Apress, Berkeley, Calif., 414 p. (2008) and in Brown, The Definitive Guide to Grails, Apress, Berkeley, Calif., 618 p. (2009).

In certain embodiments, systems and methods of the invention are implemented through the use of a mobile app. As used herein, mobile app generally refers to a standalone program capable of being installed or run on a smartphone platform such as Android, iOS, Blackberry OS, Windows 8, Windows Mobile, etc.

Functionality of the invention can be implemented by a mobile app or a software application or computer program in other formats included scripts, shell scripts, and functional modules created in development environments.

A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

A file can be a digital file, for example, stored on a hard drive, SSD, CD, or other tangible, non-transitory medium such as any of those discussed above. A file can be sent from one device to another over network 2001 (e.g., as packets being sent between a server and a client, for example, through a Network Interface Card, modem, wireless card, or similar).

The software may also reside, completely or at least partially, within the main memory and/or within the processor during execution thereof by the computer system, the main memory and the processor also constituting machine-readable media. Exemplary systems and system architectures for use with the invention are described in U.S. Pub. 2011/0209133, U.S. Pub. 2011/0175923, and U.S. Pub. 2007/0112800, each of which is incorporated by reference herein in its entirety.

The software may further be transmitted or received over network 2021 via the network interface device.

Writing a file according to the invention involves transforming a tangible, non-transitory computer-readable medium, for example, by adding, removing, or rearranging particles (e.g., with a net charge or dipole moment into patterns of magnetization by read/write heads), the patterns then representing new collocations of information about objective physical phenomena desired by, and useful to, the user (e.g., a physical arrangement of particles that indicates that a specific research center has a specific capacity to participate in a clinical trial). In some embodiments, writing involves a physical transformation of material in tangible, non-transitory computer readable media (e.g., with certain optical properties so that optical read/write devices can then read the new and useful collocation of information, e.g., burning a CD-ROM). In some embodiments, writing a file includes transforming a physical flash memory apparatus such as NAND flash memory device and storing information by transforming physical elements in an array of memory cells made from floating-gate transistors. Methods of writing a file can be invoked manually or automatically by a program or by a save command from software or a write command from a programming language.

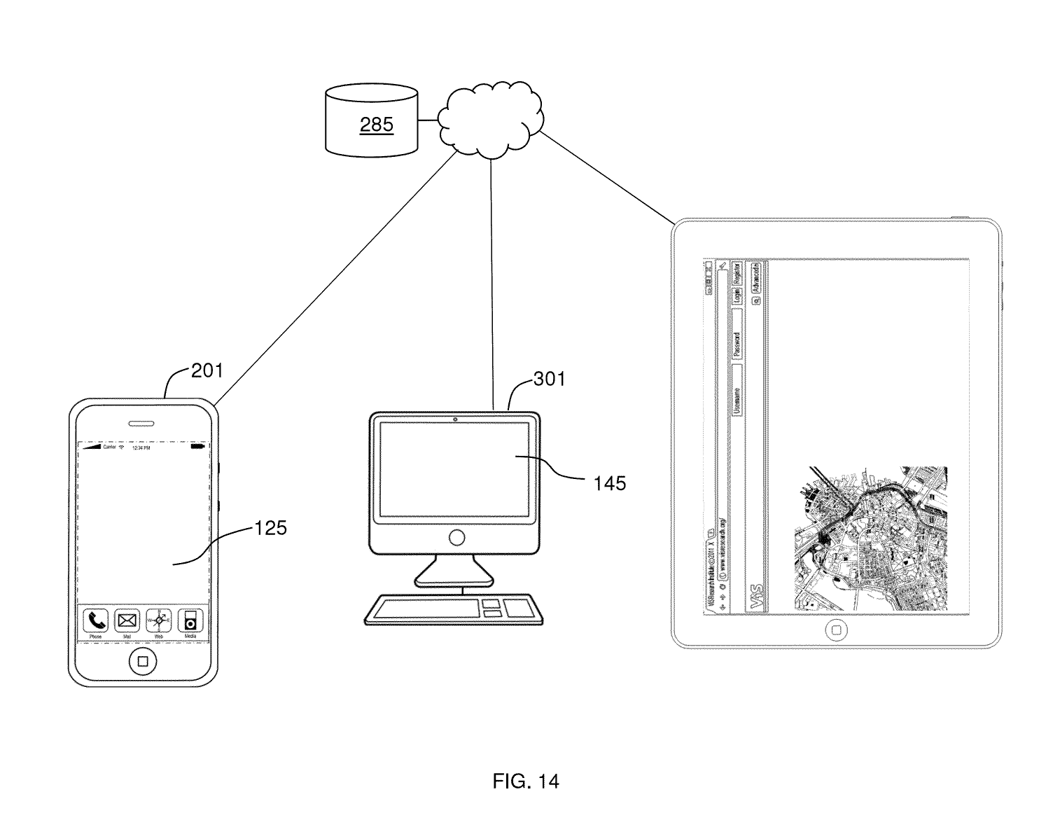

FIG. 14 depicts a system according to some embodiments. As shown in FIG. 14, displays or data provided by the invention can be accessed through the use of a smartphone 201, a PC 301, or a tablet 302. In any system or method described herein, a server may comprise a processor operably coupled to a tangible, non-transitory memory. In any system or method described herein, a server may receive a user input via a user's interaction with a computer device comprising a memory coupled to a processor, the computer device communicatively coupled to the server by a network. In any system or method described herein, a server may provide a display using markup language that is rendered on a user's computer device as a web page. As used herein, the word “or” means “and or or”, sometimes seen or referred to as “and/or”, unless indicated otherwise.

### Incorporation by Reference

References and citations to other documents, such as patents, patent applications, patent publications, journals, books, papers, web contents, have been made throughout this disclosure. All such documents are hereby incorporated herein by reference in their entirety for all purposes.

### Equivalents

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A system for providing information about clinical trial capacity by location, the system comprising:
a server computer operable to
provide a display comprising disease-specific information about clinical trial capacity associated with a location;
receive user input indicating a change in geographical scope;
alter the display to include data specific to the changed geographical scope.

2. The system of claim 1, wherein the disease-specific information comprises a mashup of data from a plurality of sources.

3. The system of claim 1, wherein the disease-specific information comprises data from an external data service.

4. The system of claim 3, wherein the disease-specific information comprises internal data integrated with the data from the external data service.

5. The system of claim 1, wherein the server computer is operable to provide the display at a country level and transition, based on the user input, the display to a city level.

6. A method providing information about clinical trial capacity by location, the method comprising:
using a server computer to
provide a display comprising disease-specific information about clinical trial capacity associated with a location;
receive user input indicating a change in geographical scope;
alter the display to include data specific to the changed geographical scope.

7. The method of claim 6, further comprising obtaining raw data from a plurality of sources and composing the display to include the raw data from the plurality of sources.

8. The method of claim 1, further comprising receiving a user query and providing the display to include a result that satisfies the user query.

9. The method of claim 8, further comprising interrogating an outside data source based on the user query and obtaining the result from the outside data source.

10. The method of claim 6, further comprising providing a disease-specific location profile for each of a plurality of nations and for at least one city within each of the plurality of nations.

11. A system for benchmarking clinical trial capacity of a geographical location, the system comprising:
a server computer operable to receive information about an aggregate capacity to conduct a disease-specific clinical trial available at each of a plurality of geographic locations;
calculate a benchmark indicating the aggregate capacity for one of the geographic locations relative to the aggregate capacity of all of the plurality of geographic locations; and
provide the benchmark to a trial planner.

12. The system of claim 11, wherein the benchmark is provided as a percentile display.

13. The system of claim 11, wherein the plurality of geographical locations includes cities and countries.

14. The system of claim 11, wherein some of the plurality of geographical locations are each contained within another of the plurality of geographic locations.

15. The system of claim 11, further comprising providing benchmarks for a plurality of aspects of clinical trial capacity.

16. A method of benchmarking clinical trial capacity of a geographical location, the method comprising:
using a server computer to:
receive information about an aggregate capacity to conduct a disease-specific clinical trial available at each of a plurality of geographic locations;
calculate a benchmark indicating the aggregate capacity for one of the geographic locations relative to the aggregate capacity of all of the plurality of geographic locations; and
provide a display comprising the benchmark to a trial planner.

17. The method of claim 16, wherein each geographic location has a plurality of clinical research centers sited therein.

18. The method of claim 16, wherein the information about the aggregate capacity comprises data retrieved from a public data source and input from a user.

19. The method of claim 16, wherein the aggregate capacity comprises identities of clinical research centers in the geographic location and the benchmark comprises a combination of weighted scores associated with the clinical research centers.

20. The method of claim 16, further comprising receiving survey results from a plurality of user's interactions with the server and aggregating the results to create the aggregate capacity.

21. A system for collecting information about clinical trial capacity of a geographical location, the system comprising:
a server computer operable to
provide a display comprising an identification of a geographical location;
receive, from a first user, input comprising information about clinical trial capacity of a geographical location;
receive, from a second user, additional input;
assign different weights to the input and the additional input;
calculate a capacity value based on the weighted inputs; and
store the calculated value for subsequent access by a clinical trial planner.

22. The system of claim 21, wherein the clinical trial capacity of a geographical location comprises an average amount of time to obtain regulatory approval in that location.

23. The system of claim 21, wherein the clinical trial capacity of a geographical location comprises information about an available patient population.

24. The system of claim 21, wherein the clinical trial capacity of a geographical location comprises cost information.

25. The system of claim 21, wherein the clinical trial capacity of a geographical location comprises an amount of time to initiate a trial.

26. The system of claim 21, wherein the clinical trial capacity of a geographical location comprises information about transportation infrastructure at a location.

27. A method for collecting information about clinical trial capacity of a geographical location, the method comprising:
using a server computer to
provide a display comprising an identification of a geographical location;
receive, from a first user, input comprising information about clinical trial capacity of a geographical location;
receive, from a second user, additional input;
assign different weights to the input and the additional input;
calculate a capacity value based on the weighted inputs; and
store the calculated value for subsequent access by a clinical trial planner.
